(19) United States
(12) Patent Application Publication
(10) Pub. No.: US 2026/0336839 A1
(43) Pub. Date: Oct. 29, 2026

(54) AN AERIAL VEHICLE PAYLOAD MODULE

(71) Applicant: Oleksandr STEPURA, Kyivska oblast (UA)

(72) Inventors: Oleksandr STEPURA, Kyivska oblast (UA); Volodymyr STEPURA, Kyivska oblast (UA)

(21) Appl. No.: 19/249,115

(22) Filed: Jun. 25, 2025

(30) Foreign Application Priority Data
Jun. 25, 2024 (UA) A 2024 03339

(51) Int. Cl. B64U 20/87; B64U 10/25

(52) U.S. Cl. CPC B64U 20/87; B64U 10/25

(57) ABSTRACT

An unmanned aerial vehicle, configured for extendable fixation of a payload to its airframe. The aerial vehicle payload module includes: a hatch connected to a fuselage lower part of the aerial vehicle and having a hole for passing the payload through; a platform with a payload fixator; a frame secured above the hole on an inner surface of the hatch by two scissor levers with the hole between these scissor levers. Each scissor lever has two immovable ends and two movable ends. One immovable end of each scissor lever is fixed to the platform rotatably in a single plane relative to a fixation point. Another immovable end of each scissor lever is coupled to an inner surface of the airframe rotatably in a single plane relative to a fixation point. Two upper guides are secured on the platform, parallel to each other and positioned between two limiters at sides of the platform where the immovable ends of the scissor levers are fixed. Two lower guides are arranged on the inner surface of the airframe and secured between two limiters, and the lower guides are parallel to each other and parallel to the upper guides. The upper guides and the lower guides have a slide between the limiters, and the movable ends of each scissor lever are fixed to the slide. Linear actuators are used as a drive for movement of the payload, and each linear actuator is fixed at one of sides of the platform, where the immovable ends of the scissor levers are fixed, rotatably in a single plane relative to a fixation point. Each of said linear actuators has rod with a threaded in bracket that is coupled to each of the scissor levers.

### CROSS-REFERENCE TO RELATED APPLICATION

This application claims priority to Ukrainian Application No. a 2024 03339, filed Jun. 25, 2024, which is hereby incorporated by reference in its entirety.

### FIELD OF THE INVENTION

The invention relates to aviation construction, in particular, to a structure of an aerial vehicle, e.g., an unmanned aerial vehicle (UAV), and it can be used for the retractable attachment of payload to the airframe of the aerial vehicle.

### BACKGROUND OF THE INVENTION

Aerial vehicles, in particular, UAVs, have an onboard payload that may be selected depending on the functions and mission being accomplished by this UAV. This payload may be a p hoto camera or a video camera secured inside a dedicated module by means of a gyrostabilized suspension, a synthetic aperture radar or other systems that are fixed to a hatch that closes said module. Usually this module is separately secured to the UAV airframe preferably in its lower part in order to protect the payload. Some payload in its operational position, e.g., the photo-camera or video camera, must be positioned outside the module during filming or data transmission. When there is no need to use the payload or the UAV needs to be landed, the payload must be moved from its operational position to a transportation position in order to be positioned inside the module Thus, the module must be equipped with a drive for moving the payload from the transportation position to the operational position and vice versa. Herewith, in both positions, it becomes necessary to protect the payload from vibrations and to ensure reliability of its movement.

A UAV payload module that is disclosed in RO129358A0 published on Apr. 30, 2014 is known. The payload is a component that comprises a device that is adapted to a flight task, e.g., a video camera with a daytime and night observation mode. Thus, the known module implies a drive for moving the video camera. The known module comprises a housing that is configured to be connected to a fuselage lower part of the UAV. The housing is provided with a hole that is closed by an extendable hatch. The hole is configured such that the video camera can pass through. The video camera is secured above the housing hole by means of the drive such that the video camera can perform a translational movement towards the hole to an extended (operational) position and upwards away from the hole, i.e., back to a transportation position (inside the module). To this end, the drive comprises two threaded studs, each of them is secured between two supports and rotatably relative to its axis. In turn, the supports are immovably secured on two opposite walls of a frame parallelepiped-shaped structure, and a lower base of the parallelepiped is secured on an inner surface of the housing. A nut is screwed on each of the threaded studs. The nuts of each of the threaded studs are coupled between each other by means of a bracket. The video camera is fixed to a lower base of the bracket by means of a gyrostabilized suspension. Threaded studs are rotated by means of electromotors and sets of gear wheels, one of the gear wheels in each set is coupled to the threaded stud, while another gear wheel is coupled to a shaft of the electromotor. A drawback of the above-described module is the drive for movement of the video camera, wherein its translational movement is ensured by the gear wheels and the threaded studs with the nuts. In order to ensure operation of said elements of the drive, it is necessary to provide their mutual coaxiality and rotatability one relative to another. If these conditions are not met, the specified elements may become jammed inhibiting the translational movement of the video camera that may lead either to an inability to extend it to the operational position or to its damage, e.g., during landing, if the drive is jammed in the extended position. Also, a drawback lies in that there is no anti-vibration protection of the video camera that is caused by its fixation structure that may lead to damage of this fixation and possible loss of the video camera.

A UAV payload module structure is disclosed in CN217416129 U published on Sep. 13, 2022. A video camera having a gyrostabilized suspension is used as the payload. The prototype module implies a drive for moving the video camera from a transportation position to a operational position. The module comprises a hatch that is configured to be connected to a lower portion of a fuselage of the UAV. The hatch is provided with a hole that is configured such that the video camera can pass through. The module further comprises a platform and a frame that is connected to the platform by means of two scissor levers. The platform is equipped with a payload fixator. The frame is secured above the hole on an inner surface of the hatch. The two scissor levers are mounted such that the hole is positioned between these scissor levers. Each scissor lever has a multilink structure that is, from the top, hingedly coupled too the platform and, from the bottom, coupled to the frame that is mounted above the hole. Driving groups are used as the drive for movement the video camera, and each of the driving groups is secured on the frame and includes a driving motor that is connected to a driving screw that is in turn connected to a lower portion of one link of the scissor lever. The video camera fixator comprises a damper that is secured on a lower surface of the platform and coupled to the gyrostabilized suspension. A drawback of the prototype is an increased load acting onto the driving groups due to their arrangement in the lower portion of the scissor levers, thereby resulting in receiving an overall load from the scissor levers and from the platform with the video camera fixator. The increased load acting onto the driving groups may reduce the reliability of the drive operation and increase power consumption for movement of the video camera. Also, a drawback is an increased number of actuated assemblies in the scissor levers and in the drive for movement of the video camera, thereby further reducing the reliability of its movement to the operational position and to the transportation position, as well as complicating positioning of the video camera in the operational position and maintainability of the entire module.

### SUMMARY OF THE INVENTION

Embodiments of the subject invention provide an aerial vehicle payload module that is configured to move the payload multiple times from a transportation position to an operational position for which the payload must be positioned outside the module, and to move the payload from the operational position to the transportation position for which the payload must be positioned inside the module.

In certain embodiments, an aerial vehicle payload module comprises a drive for moving the payload, a hatch that is configured to be coupled to a fuselage lower part of the aerial vehicle, and the hatch is provided with a hole for passing the payload through, a platform that is equipped with a payload fixator, a frame that is secured above the hole on the inner surface of the hatch by means of two scissor levers that are arranged such that the hole is positioned between these scissor levers, each of the scissor levers has two immovable ends and two movable ends, one of the immovable ends of each of the scissor levers is fixed to the platform rotatably in a single plane relative to a fixation point, another immovable end of each of the scissor levers is directly or indirectly coupled to the inner surface of the hatch rotatably in a single plane relative to a fixation point, and two upper guides are secured on the platform, the upper guides are parallel to each other and arranged between two limiters at those sides of the platform, where the immovable ends of the scissor levers are fixed, while two lower guides are directly or indirectly arranged on the inner surface of the hatch, the lower guides are secured between the two limiters in parallel to each other and in parallel to the upper guides, the upper guides and the lower guides have a slide between the limiters, and the movable end of each of the scissor levers is fixed to the slide, and linear actuators are used as the drive for moving the payload, each of the linear actuators is secured at any side of the platform, where the immovable ends of the scissor levers are fixed, rotatably in a single plane relative to the fixation point, while each of said linear actuators has a rod with a threaded in bracket that is coupled to one of the scissor levers.

A technical effect that is achieved upon use of the aerial vehicle payload module according to the invention lies in increase of the reliability of the payload movement between the transportation position and the operational position that is caused by reduction of the load acting onto the drive for the payload movement being the linear actuators and by reduction of the number of the actuated assemblies due to fixation of the linear actuators to the platform, as well as the structure of the scissor levers and their coupling to the platform and to the inner surface of the module housing.

According to one of embodiments of the invention, the payload fixator comprises a vibration isolation frame that in turn comprises a bracket having one end that is fixed to the payload and another end is fixed to a damper that is secured on the platform. It ensures achievement of an additional technical effect that lies in providing an increased anti-vibration protection for the payload in the operational position and in the transportation position, as well as to gyrostabilization, that is particularly applicable for the operation of a photo camera or a video camera. Herewith, the above-described vibration isolation frame allows to facilitate positioning of the payload in the operational position that is also applicable for the operation of a photo camera or a video camera, as well as increases a maintainability of the fixator.

According to another embodiment of the invention, electrical linear sliding actuators are used as the linear actuators. In this embodiment, the module may comprise an actuator controller that is electrically connected to each of the actuators, thereby ensuring synchronization of their operation and smooth operation of the drive with regard to movement of the platform with the payload secured thereon between the transportation position and the operational position. Also, in this embodiment, the module may further comprise a frame that is secured on the inner surface of the housing above the hole, while two immovable ends of the scissor levers and two lower guides with the limiters and the slide are secured on the frame, thereby allowing to simplify the fixation of the payload inside the module and equipping the module with the movement drive, as well as to further simplify its maintainability.

### BRIEF DESCRIPTION OF FIGURES

An exemplary embodiment of the inventive payload module for the unmanned aerial vehicle (hereinafter referred to as the module) is provided herein below and illustrated with the following Figures:

FIG. 1 illustrates a general view of the unmanned aerial vehicle with the module secured,

FIG. 2 illustrates a general view of the module separately from the unmanned aerial vehicle, when the payload is in the transportation position,

FIG. 3 illustrates a general view of the module separately from the unmanned aerial vehicle, when the payload is in the operational position,

FIG. 4 illustrates a top view of the module with the drive for movement of the payload in its operational position (the payload is not shown),

FIG. 5 illustrates a separate general view of the platform with the scissor levers and the drive for movement of the payload in its transportation position (the module and the payload are not shown),

FIG. 6 illustrates a separate side view of the platform with the scissor levers and the drive for movement of the payload in its transportation position (the module and the payload are not shown),

FIG. 7 illustrates a separate general view of the platform with the scissor levers and the drive for movement of the payload in its operational position (the module and the payload are not shown),

FIG. 8 illustrates a separate side view of the platform with the scissor levers and the drive for movement of the payload in its operational position (the module and the payload are not shown).

The provided example and Figures do not limit other possible embodiments of the inventive module, rather they merely explain its essence and confirm the possibility of implementation thereof.

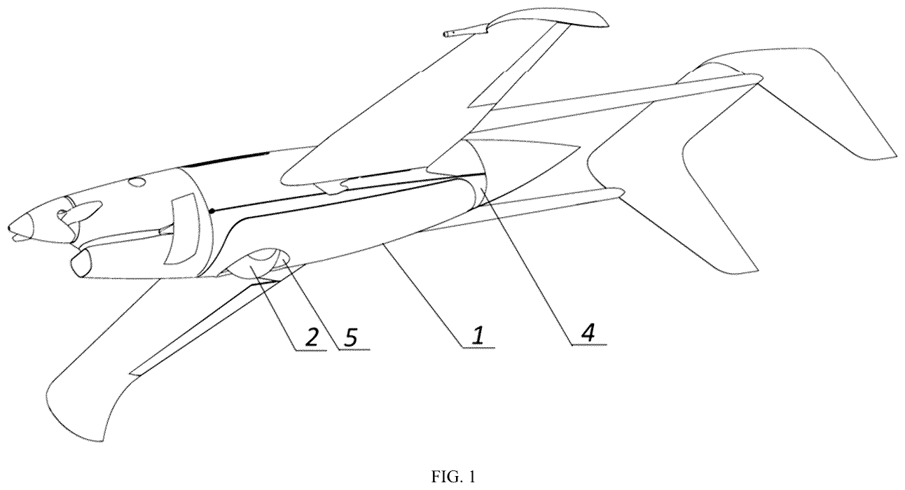

In FIGS. 1-8, the following designations are used:
1—the payload module,
2—the payload,
3—the hatch,
4—the fuselage of the aerial vehicle,
5—the hole,
6—the platform,
7, 8—the scissor levers,
9—the vibration isolation frame,
10—the bracket,
11—the damper,
12, 13—the immovable ends of the scissor levers,
14, 15—the movable ends of the scissor levers,
16—the fixation point of the immovable end (12),
17—the fixation point of the immovable end (13),
18—the upper guide,
19—the limiter,
20—the slide,
21—the lower guide,
22—the limiter,
23—the slide,
24—the frame,
25—the linear actuators,
26—the rod of the linear actuator (25),
27—the rod end of the linear actuator (25),
28—the fixation point of the linear actuators (25).

### Data Confirming a Possibility of the Invention Implementation

FIG. 1 illustrates a UAV having a payload module (1) (hereinafter referred to as the module (1)), where a video camera with a gyrostabilized suspension is used as a payload (2). The module (1) comprises a hatch (3) that is configured to be connected to of a fuselage (4) lower part of the aerial vehicle. The hatch (3) of the module (1) is provided with a hole (5) for passing the payload (2) through. According to FIG. 1, the payload (2) is shown in a transportation position, when it is positioned in the hole (5) inside the module (1).

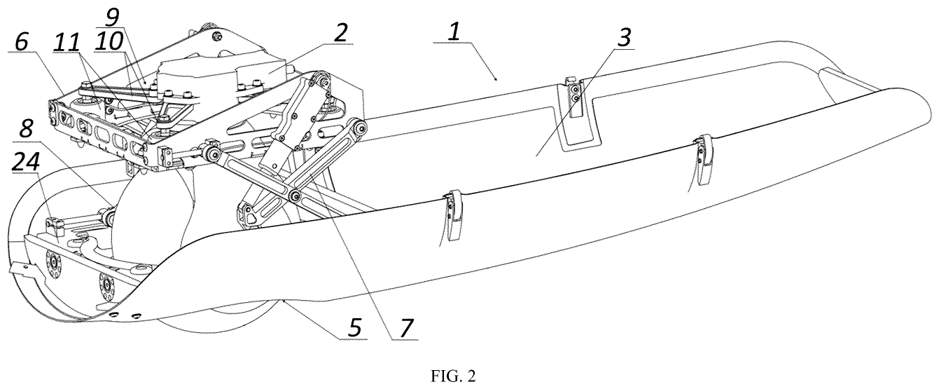

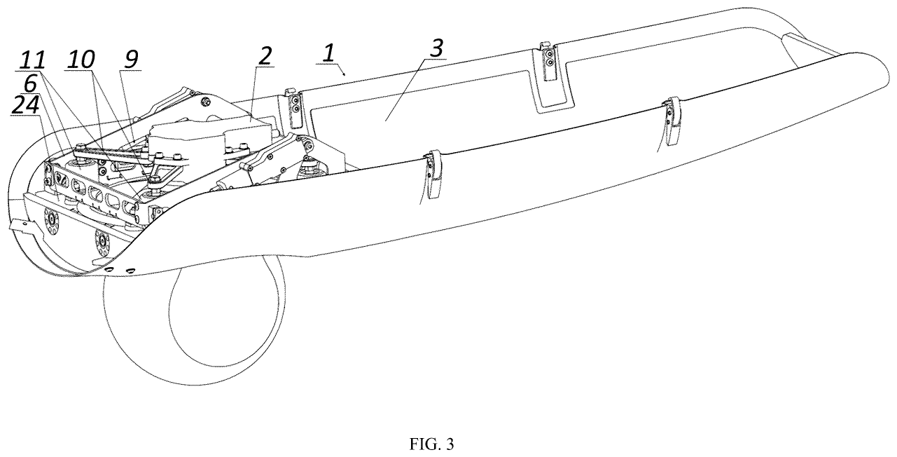

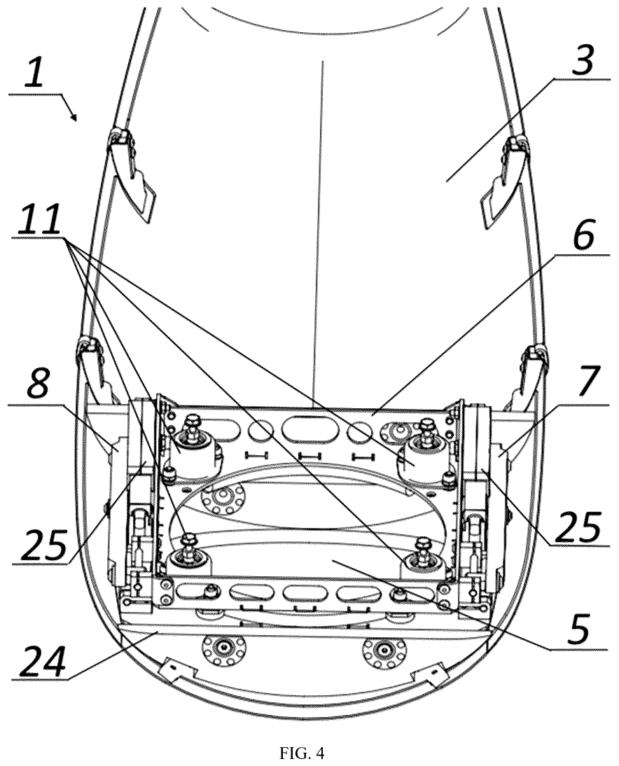

FIGS. 2 and 3 illustrate the module (1) separately from the UAV. According to FIG. 2, the module (1) comprises a platform (6) that is equipped with a payload fixator, a frame (24) that is secured above the hole (5) on an inner surface of the hatch (3) and connected to the platform by means of two scissor levers (7), (8). The scissor levers (7), (8) are mounted such that the hole (5) is positioned between these scissor levers (7), (8). The payload fixator comprises a vibration isolation frame (9). The vibration isolation frame (9) comprises a bracket (10). One end of each bracket (10) is fixed to the payload (2) being the gyrostabilized suspension of the video camera by means of threaded elements, while another end is fixed to a damper (11) that is secured on the platform (6). According to the example that is illustrated in FIG. 2, the platform (6) is rectangular in a plane, while the vibration isolation frame (9) comprises four brackets (10) that are coupled to four dampers (11), and each of the dampers is secured in corners of the platform (6). The damper (11) is a vibration-isolating device having a housing, where a vibration-isolating element or material are provided and coupled to a threaded stud with hexagonal head that is protruded from the housing for securing one of the ends of the bracket (10). FIG. 3 illustrates the module (1), when the payload (2) is in a operational position. FIG. 4 illustrates an arrangement of the platform (6) above the hole (5).

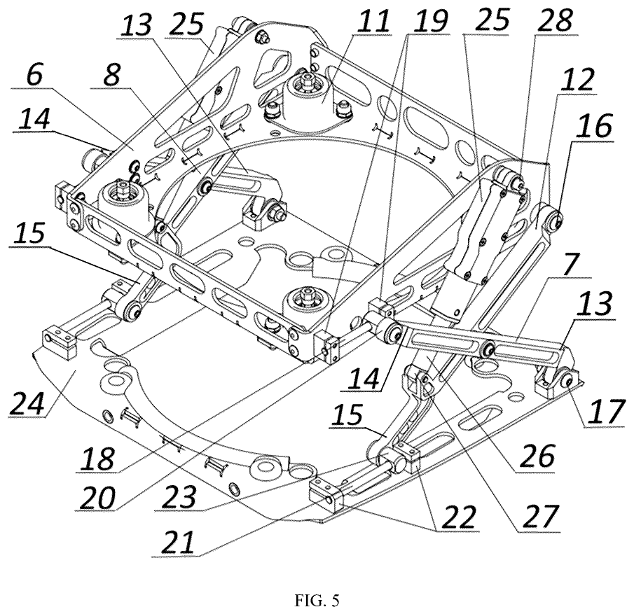

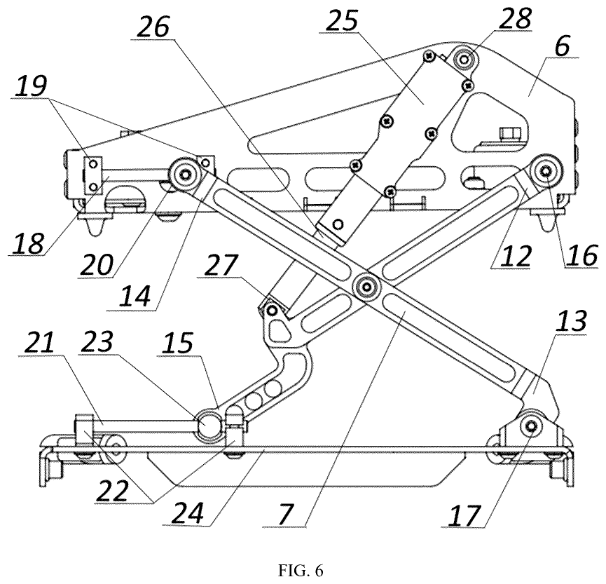

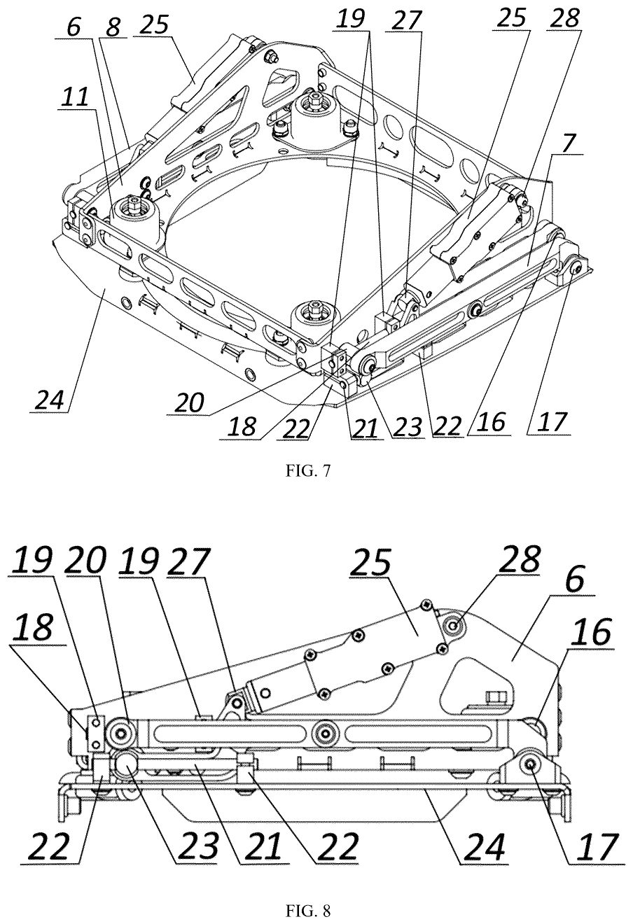

FIGS. 5 and 6 illustrate the platform (6) in the transportation position (the payload (2) and the brackets (10) of the vibration isolation frame (9) are not shown) with the scissor levers (7), (8) and the drive for movement of the payload. Each scissor lever (7), (8) has two immovable ends (12), (13) and two movable ends (14), (15). One immovable end (12) of each scissor lever (7), (8) is fixed to the platform (6) rotatably in a single plane relative to a fixation point (16), another immovable end (13) of each scissor lever (7), (8) is directly or indirectly coupled to the inner surface of the body (3) rotatably in a single plane relative to a fixation point (17). Two upper guides (18) are secured on the platform (6), and the upper guides are parallel to each other and positioned between two limiters (19) at any side of the platform (6), where the immovable ends (12) of the scissor levers (7), (8) are fixed. Two lower guides (21) are arranged on the frame (24) and secured between two limiters (22), and the lower guides are parallel to each other and parallel to the upper guides (18). The upper guides (18) have a slide (20) between the limiters (19), and the movable end (14) of each scissor lever (7), (8) is secured to the slide. The lower guides (21) have a slide (23) between the limiters (22), and the movable end (15) of each scissor lever (7), (8) is secured to the slide. According to the example that is illustrated in FIG. 5, the two lower guides (21) are arranged on the inner surface of the hatch (3) indirectly by means of the frame (24), however, the lower guides (21) with the limiters (22) and the slide (23) may be secured directly on the inner surface of the hatch (3). The frame (24) has a rectangular shape in a plane and secured on the inner surface of the hatch (3) above the hole (5). Both immovable ends (13) of the scissor levers (7), (8) are also secured on the frame (24). Linear actuators (25), e.g., electrical linear sliding actuators, are used as the drive, the actuator have a pillar (26) having a staple (27) that is coupled to one of the scissor levers (7), (8). Each of the linear actuators (25) is secured at those side of the platform (6), where the immovable ends (12) of the scissor levers (7), (8) are fixed, rotatably in a single plane relative to a fixation point (28). The payload module (1) further comprises an actuator controller (not shown in the drawings) that is electrically connected to each of the actuators (25). The actuator controller is also connected to a UAV controller and a power supply unit thereof that are arranged inside the aerial vehicle fuselage (4). FIGS. 7 and 8 illustrate the platform (6) in the operational position (the payload (2) and the brackets (10) of the vibration isolation frame (9) are not shown).

Example of the drive operation for movement of the payload in the above-described module is as follows. In the transportation position of the payload (2), the latter is positioned inside the module (1) in the hole (5) of the hatch (3) as shown in FIGS. 1 and 2. Therewith, the platform (6) with the vibration isolation frame (9) with the payload (2) fixed thereto is positioned in its upper position and held therein by means of the scissor levers (7), (8) as shown in FIGS. 5 and 6. If the payload (2) needs to be moved from the transportation position into the operational position, the latter is moved downwards through the hole (5) to arrange it outside the module (1) as shown in FIG. 3. To this end, the power is supplied to the linear actuators (25) via the actuator controller. The rods (26) of the linear actuators (25) are retracted synchronously and transmit the movement to the scissor levers (7), (8) via the rod end (27). The scissor levers (7), (8) are synchronously clamped and move the platform (6) downwards. Herewith, the movable end (14) of each scissor lever (7), (8) moves the slide (20) along the upper guides (18) from one limiter (19) to the opposite limiter (19), and the movable end (15) of each scissor lever (7), (8) simultaneously moves the slide (23) along the lower guides (21) from one limiter (22) to the opposite limiter (22). When the slide (20) reaches the opposite limiter (19) and the slide (23) reaches the opposite limiter (22), the actuator controller terminates the power supply to the linear actuators (25), thereby terminating the retraction of the rods (26) and the movement of the scissor levers (7), (8) coupled thereto. Herewith, the platform (6) takes the lower position above the frame (24) as shown in FIGS. 7 and 8, and the payload (2) being the video camera with the gyrostabilized suspension that is fixed to the platform (6) via the vibration isolation frame (9) passes through the hole (5) and takes the operational position outside the payload module (1) below the hatch (3). Owing to the fixation of the payload (2) to the platform (6) by means of the brackets (10) and the dampers (11), the vibration isolation frame (9) ensures isolating of the vibration of the payload (2) during its operation.

In order to return the payload (2) back to the transportation position, e.g., when there is no need to use it or when the UAV is going to land, an inverted order of actions should be performed, in particular, the power is supplied to the linear actuators (25) via the actuator controller to ensure the synchronous ejection of the rods (26) of the linear actuators (25) and to declamp the scissor levers (7), (8). Herewith, the movable end (14) of each scissor lever (7), (8) moves the slide (20) along the upper guides (18) to the opposite limiter (19), and the movable end (15) of each scissor lever (7), (8) simultaneously moves the slide (23) along the lower guides (21) to the opposite limiter (22). When the slide (20) reaches the opposite limiter (19) and the slide (23) reaches the opposite limiter (22), the actuator controller terminates the power supply to the linear actuators (25), thereby terminating the ejection of the rods (26) and the movement of the scissor levers (7), (8) coupled thereto. Therewith, the platform (6) takes the upper position above the frame (24), while the payload (2) being the video camera with the gyrostabilized suspension that is fixed to the platform (6) via the vibration isolation frame (9) lifts upwards and positions in the hole (5) inside the payload module (1).

Therefore, the invention ensures the possibility of movement of the payload multiple times from the transportation position to the operational position and vice versa in the module, while increasing the reliability of the payload movement and its protection from vibrations in the operational position and in the transportation position, as well as facilitating positioning of the payload in the operational position and increasing the maintainability of the payload fixator and the entire module.

1. An aerial vehicle payload module, comprising: a drive configured to move the payload; a hatch configured to be fixed to a fuselage lower part of the aerial vehicle, the hatch is provided with a hole for passing the payload through; a platform that is equipped with a payload fixator; and a frame that is secured above the hole on an inner surface of the hatch and connected to the platform by two scissor levers that are arranged such that the hole is positioned between these scissor levers, wherein each of the scissor levers has two immovable ends and two movable ends, one of the immovable ends of each of the scissor levers is fixed to the platform rotatably in a single plane relative to a fixation point, another immovable end of each of the scissor levers is coupled to the frame rotatably in a single plane relative to a fixation point, and two upper guides are secured on the platform, the upper guides are parallel to each other and arranged between two limiters at sides of the platform, where the immovable ends of the scissor levers are fixed, while two lower guides are arranged on the frame, the lower guides are secured between the two limiters in parallel to each other and in parallel to the upper guides, the upper guides and the lower guides have a slide between the limiters, and the movable end of each of the scissor levers is fixed to the slide, and linear actuators are used as the drive for moving the payload, each of the linear actuators is secured at any side of the platform, where the immovable ends of the scissor levers are fixed, rotatably in a single plane relative to the fixation point, while each of said linear actuators has a rod with a threaded in bracket that is coupled to one of the scissor levers.

2. The module according to claim 1, wherein the payload fixator comprises a vibration isolation frame.

3. The module according to claim 2, wherein the vibration isolation frame comprises brackets, each bracket having one end that is fixed to the payload and another end that is fixed to a vibration damper that is secured on the platform.

4. The module according to claim 1, wherein electrical linear sliding actuators are used as the linear actuators.

5. The module according to claim 4, further comprising an actuator controller that is electrically connected to each of the linear actuators.
